(19) United States
(12) Patent Application Publication
(10) Pub. No.: US 2004/0070533 A1
(43) Pub. Date: Apr. 15, 2004

(54) Array antenna receiving apparatus and method for calibrating the same

(76) Inventor: Tomohiro Azuma, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/415,375

(22) PCT Filed: Oct. 26, 2001
(86) PCT No.: PCT/JP01/09450

(30) Foreign Application Priority Data
Oct. 27, 2000 (JP) 2000-328846

(51) Int. Cl. G01S 7/40

(52) U.S. Cl. 342/174; 342/417; 342/154

(57) ABSTRACT

A calibration method, which allows calibration with high precision and which can perform calibration normally even when a specific radio receiving portion has a problem, and an array antenna receiving apparatus using the method. The array antenna receiving apparatus multiplexes calibration signals having predetermined symbol patterns from a multiplexing circuit (103) to signals received by array antennas (101) and inputs the results to radio receiving portions (104). The calibration signals having passed through the radio receiving portions are extracted by a calibration signal extracting portion (110), and an SIR detecting portion (111) determines one of the radio receiving portions having the best receiving quality as a reference branch based on the calibration signals. A calibration signal processing portion (109) corrects receiving-oriented patterns by using the phase differences and amplitude ratios between the calibration signal having passed through the obtained reference branch and the calibration signals having passed through the other radio receiving portions.

### TECHNICAL FIELD

The present invention relates to a calibration method for correcting the change in phase and amplitude between radio receiving portions of array antennas and to an array antenna receiving apparatus using the method. In particular, the present invention relates to a calibration method, which allows highly precise calibration and which can calibrate normally even when a specific radio receiving portion fails.

### BACKGROUND ART

Conventionally, an array antenna receiving apparatus is used for forming a desired receiving-oriented pattern by using highly correlated multiple antenna elements in a cellular mobile communication system. In other words, a receiving method has been reviewed for using the receiving apparatus to increase a receiving gain to a direction that a desired signal comes from and to decrease a receiving gain against an interference from other users or an interference due to delay waves. According to this method, the speed and quality of received and sent signals are increased such that the subscriber capacity can be increased.

In an array antenna receiving apparatus including multiple radio receiving portions corresponding to antenna elements, the amplitudes and phases of the radio receiving portions generally change independently from each other vry moment. Therefore, the changes in phase and amplitude must be compensated in order to form a desired receiving-oriented pattern correctly. The compensating operation is called calibration.

Conventionally, this kind of calibration method for an array antenna receiving apparatus is disclosed in JP-A-11-46180. According to this method, a known calibration signal is input to the radio receiving portions connected to multiple antennas. Then, the calibration signals extracted from the outputs of the radio receiving portions are demodulated, and the result is used to correct the independent, every moment changes in phase and amplitude of the radio receiving portions.

FIG. 1 is a block diagram showing one constructional example of a conventional array antenna receiving apparatus.

The shown array antenna receiving apparatus includes an array antenna 001, multiplexing circuits 003-1 to 003-N, radio receiving portions 004-1 to 004-N, signal processing portions 005-1 to 005-M, a calibration signal generator 006, a calibration radio sending portion 007, an electric power level varying circuit 008, a calibration signal processing portion 009 and a calibration signal extracting portion 010. In the array antenna receiving apparatus, the array antenna 001 includes N antenna elements 002-1 to 002-N. The array antenna 001 can demodulate signals equal to a number M of users.

The antenna elements 002-1 to 002-N are located closely to each other such that receiving signals of the antenna elements can correlate with each other. Each of the antenna elements 002-1 to 002-N receives a signal in which a desired signal and multiple interference signals are multiplexed. In order to distinguish from the general diversity construction, the number, N, of antenna elements is three or above here.

The multiplexing circuits 003-1 to 003-N correspond to the antenna elements 002-1 to 002-N, respectively. The multiplexing circuits 003-1 to 003-N are input and multiplex, in a radio band, output signals of the electric level varying circuit 008 and signals received by the respective antenna elements 002-1 to 002-N. The multiplexed signals are output to the radio receiving portions 004-1 to 004-N. The multiplexing method is not limited in particular. Though a typical code division multiplexing example is described here, a time division multiplexing method or a frequency division multiplexing method may be used.

The radio receiving portions 004-1 to 004-N correspond to the multiplexing circuits 003-1 to 003-N, respectively. Each of the radio receiving portions 004-1 to 004-N includes devices such as a low-noise amplifier, a band-limited filter, a mixer, a local oscillator, an Auto Gain Controller (AGC), an orthogonal detector, a low-pass filter and an analog-to-digital converter (ADC). The radio receiving portions 004-1 to 004-N receive radio waves through the respective antenna elements (001-1 to 001-N), convert to digital signals and output the digital signals. For example, the radio receiving portion 004-i corresponding to the antenna element 002-i performs the amplification, frequency conversion from the radio band to the base band, orthogonal detection, and analog-to-digital conversion on input signals received from the multiplexing circuit 003-i. Then, the radio receiving portion 004-i outputs the result to the calibration signal extracting portion 010 and all of the signal processing portions 005-1 to 005-M. Each of the radio receiving portions 004-1 to 004-N has the same construction as that of the radio receiving portion 004-i. Signals received from the multiplexing circuit 003-1 to 003-N are input to the respective radio receiving portions 004-1 to 004-N.

The calibration signal extracting portion 010 extracts N calibration signals multiplexed to input signals received from the radio receiving portions 004-1 to 004-N and sends the extracted signals to the calibration signal processing portion 009. Here, the calibration signal extracting portion 010 extracts calibration signals multiplexed to input signals by a method compliant with the multiplexing method used in the multiplexing circuits 003-1 to 003-N. The calibration signal processing portion 009 creates phase/amplitude correction information S01-1 to S01-N from the extracted N calibration signals and outputs all of the created information to the signal processing portions 005-1 to 005-M.

Here, the method for creating phase/amplitude correction information in the calibration signal processing portion 009 will be described with reference to FIGS. 2 and 3 in addition to FIG. 1.

FIG. 2 is a diagram showing symbol points obtained by demodulating calibration signals. FIG. 3 is a diagram showing symbol points obtained by normalizing the symbol points in FIG. 2. The symbol point here refers to a point on I-Q coordinates.

One of the radio receiving portions 004-1 to 004-N is used as a reference, and the phase/amplitude correction information is information for correcting phase and amplitude shifts in the other radio receiving portions with respect to the reference. Each of the radio receiving portions is called branch, and the reference radio receiving portion is called reference branch.

Here, the radio receiving portion 004-1 is the reference branch, for example, and “N” is assumed as “3”. The symbol point obtained by demodulating a calibration signal extracted from output signals of the radio receiving portion 004-1 is the reference symbol point S1 in FIG. 2. Similarly, the symbol point obtained by demodulating a calibration signal extracted from the output of the radio receiving portion 004-2 is S2. The symbol point obtained by demodulating a calibration signal extracted from the output of the radio receiving portion 004-3 is S3. A phase difference θ2 and amplitude ratio r2 (=B/A) between the reference symbol point S1 and the symbol point S2 are phase/amplitude correction information S01-2 corresponding to the radio receiving portion 004-2 branch. A phase difference θ and amplitude ratio r3 (=C/A) between the reference symbol point S1 and the symbol point S3 are phase/amplitude correction information S01-3 corresponding to the radio receiving portion 004-3 branch. In the phase/amplitude correction information S01-1 of the reference branch, a phase difference θ1 is zero (0) and amplitude ratio r1 is “1”.

When the symbol points S1, S2 and S3 in FIG. 2 are normalized with respect to the symbol point S1, the calibration signal processing portion 009 can obtain the symbol points S1_{NOR}, S2_{NOR} and S3_{NOR} in FIG. 3. Since the values of the amplitude ratios r2 and r3 do not vary, the amplitude ratios r2 and r3 can obtain as “B/A=B_{NOR}” and “C/A=C_{NOR}”, respectively.

The calibration signal processing portion 009 outputs the phase/amplitude correction information S01-1 to S01-N obtained by the above-described creating method to all of the signal processing portions 005-1 to 005-M, respectively, every calibration period.

The signal processing portions 005-1 to 005-M assign predetermined weights on output signals of the radio receiving portions 004-1 to 004-N, respectively. Therefore, for example, the signal processing portion 005-i forms a receiving-oriented pattern for increasing a receiving gain to the user signal incoming direction of the user corresponding to the signal processing portion 005-i and for decreasing a receiving gain to an interference from the other user or an interference due to delay waves. The signal processing portion 005-i combines outputs of the radio receiving portions 004-1 to 004-N based on the receiving-oriented pattern and obtains a desired demodulated signal S00-i. Also, the signal processing portion 005-i uses the phase/amplitude correction information S01-1 to S01-N output from the calibration signal processing portion 009 to correct the phases and amplitudes of the output signals from the radio receiving portions 004-1 to 004-N.

The calibration signal generator 006 generates a calibration signal having a predetermined pattern in a base band and sends the calibration signal to the calibration radio sending portion 007.

The calibration radio sending portion 007 performs digital-to-analog conversion, frequency conversion from the base band to the radio band and the like on the calibration signal in the base band received from the calibration signal generator 006 and outputs the result to the electric power level varying circuit 008.

The electric power level varying circuit 008 sends calibration signals in the radio band received from the calibration radio sending portion 007 to the multiplexing circuits 003-1 to 003-N at an arbitrary electric power level.

Signals received by the N antenna elements 002-1 to 002-N include a desired signal component, an interference signal component and thermal noise. A multi-path component exists in each of the desired signal component and interference signal component. Generally, these signal components come from different directions from each other.

The conventional array antenna receiving apparatus shown in FIG. 1 uses phase/amplitude information of the signals received by the N antenna elements 002-1 to 002-N to identify each of the signal components having the different incoming direction respectively and to form a receiving-oriented pattern.

When the phase/amplitude changes occur independently from each other within the radio receiving portions 004-1 to 004-N due to the devices included in the radio receiving portions 004-1 to 004-N without the correction at the time of the pattern forming, the signal processing portions 005-1 to 005-M are input signals having the signals received by the antenna elements 002-1 to 002-N containing the extra phase/amplitude changes. Therefore, each of the signal components cannot be identified accurately, and an ideal receiving-oriented pattern cannot be formed.

Thus, calibration signals having the same frequency band with the signals received by the antenna elements 002-1 to 002-N are multiplexed to the received signals. Then, the changes in phase/amplitude are detected from the calibration signals extracted from the output signals of the radio receiving portions 004-1 to 004-N in the calibration signal processing portion 009, and phase/amplitude correction information S01-1 to S01-N are created. Then, the receiving-oriented pattern is corrected in the signal processing portions 005-1 to 005-M.

According to the calibration method, calibration signals are multiplexed to signals received by the antenna elements 002-1 to 002-N. Therefore, the calibration is possible during operations.

Even when the change in phase/amplitude occurs within the radio receiving portions 004-1 to 004-N during operations in the conventional array antenna receiving apparatus using the above-described calibration method, the phase/amplitude information to be given to the signal processing portion 005-1 to 005-M can be corrected. Therefore, the conventional array antenna receiving apparatus shown FIG. 1 can always perform correction by using the phase/amplitude correction information S01-1 to S01-N created from the results obtained by demodulating calibration signals multiplexed to signals received by N antenna elements 002-1 to 002-N. At the same time, the conventional array antenna receiving apparatus can identify the signal components having different incoming directions and can form an ideal, receiving-oriented pattern.

Though the above-described array antenna receiving apparatus has these merits, the array antenna receiving apparatus is not preferable for reasons mentioned below.

First of all, the problems will be described with reference to FIGS. 4 and 5.

FIG. 4 is a diagram showing a state of a symbol point Sn (In, Qn) (1≦n≦N) obtained by demodulating an arbitrary calibration signal. FIG. 5 is an enlarged diagram of the vicinity of the symbol point Sn. The symbol point Sn is an ideal symbol point when the SIR (signal to interference ratio) value of the calibration signal is infinite where the amplitude is Rn.

In reality, the interference component exists in addition to the calibration signals, and the SIR value cannot become infinite. Therefore, the symbol point to be actually demodulated is located at a position within a predetermined range. The predetermined range is within a circle C1 having a smaller radius d1 when the interference component is small and the SIR value is large. On the other hand, when the interference component is large and the SIR value is small, the range is within a circle C2 having a larger radius d2. Therefore, as the SIR value decreases, the error in symbol point to be actually demodulated increases.

When the range of the symbol point obtained by the demodulation has the radius d2, the magnitude of the phase error is the maximum θ as shown in FIG. 4. Therefore, the maximum value and minimum value of the phase of the symbol point obtained by the demodulation can be θn#max (=θn+θ) and θn#min (=θn−θ), respectively. The error in amplitude is the maximum of d2. Therefore, the maximum value and minimum value of the amplitude of the symbol point obtained by the demodulation can be Rn#max (=Rn+d2) and Rn#min (=Rn−d2), respectively.

Here, for the simple description, a case where the symbol point S1 is always the reference symbol point will be described with reference to FIGS. 6 and 7.

FIG. 6 is a diagram showing relative positions of other symbol points when the phase error of the reference symbol point S1 is the maximum −θ and the amplitude error is zero. FIG. 7 is a diagram showing the relative magnitude of the amplitudes of the other symbol points when the amplitude error of the reference symbol point S1 is the maximum, −d2. In FIGS. 6 and 7, the SIR values of the symbol points S2 and S3 are large enough with respect to the SIR value of the reference symbol point S1.

In FIG. 6, when the reference symbol point S1 has the phase error −θ, phase offsets occur in the symbol points S1_{NN}, S2_{NN} and S3_{NN} normalized with respect to the reference symbol point S1. In FIG. 7, when the reference symbol point S1 has an amplitude error, amplitude errors occur in the symbol points S1_{NNN}, S2_{NNN} and S3_{NNN} normalized with respect to the reference symbol point S1.

As described above, when the reference symbol point includes an error, large errors are given to symbol points obtained by demodulating calibration signals extracted from the outputs of all branches except the branch having the reference symbol point.

In other words, one specific radio receiving portion is selected and is fixed as a reference branch in the conventional array antenna receiving apparatus. Therefore, when the SIR value of the reference symbol point obtained by demodulating a calibration signal extracted from the output of the reference branch is small, errors may occur the phase difference and amplitude rate in comparison with the symbol points obtained by demodulating calibration signals extracted from the outputs of the other branches. As a result, a problem that the calibration precision is decreased is caused.

When a problem such as a breakdown occurs in a specific radio receiving portion set and fixed as a reference branch, the precision of the calibration of the array antenna receiving apparatus is disadvantageously decreased extremely.

Therefore, it is an object of the invention to provide a calibration method and array antenna receiving apparatus, which have higher precision in calibration and which can perform calibration normally even when a specific radio receiving portion has a problem.

### DISCLOSURE OF INVENTION

The invention is a calibration method for an array antenna receiving apparatus having an array antenna including multiple antenna elements for forming a receiving-oriented pattern and radio receiving portions corresponding to the antenna elements, the method including the following steps. The steps are of: supplying calibration signals having predetermined symbol patterns to the radio receiving portions; extracting the calibration signal having passed the radio receiving portions from outputs of the radio receiving portions; determining the radio receiving portion having the best receiving quality from the calibration signal having passed the radio receiving portions and selecting a predetermined one of the radio receiving portions as a reference branch; and correcting the receiving-oriented pattern by using at least one of the phase differences and amplitude ratios between the calibration signal having passed through the other radio receiving portions and the calibration signal having passed through the reference branch. The above steps of determining and selecting the predetermined radio receiving portion are characteristics of the invention.

Thus, the phase differences and amplitude ratios of the other radio receiving portions are determined by using the radio receiving portion having the best receiving quality as the reference. Therefore, minimizing the error in the reference branch, the other radio receiving portions can be calibrated. Furthermore, as the radio receiving portion having the best receiving quality is selected as the reference, a radio receiving portion having a problem is not selected as the reference branch.

According to one embodiment of the method of the invention, the step of supplying calibration signals having predetermined symbol patterns to the radio receiving portions multiplexes the calibration signals to input signals. Thus, radio communication and calibration can be performed at the same time.

According to another embodiment of the method of the invention, the step of selecting the radio receiving portion as the reference branch determines the radio receiving portion having the best receiving quality based on the SIR values estimated from the calibration signals having passed through the plurality of radio receiving portions or based on the error rates of the calibration signals having passed through the radio receiving portions.

The invention relates to an array antenna receiving apparatus having an array antenna including multiple antenna elements for forming a receiving-oriented pattern and radio receiving portions corresponding to the antenna elements. The array antenna receiving apparatus further includes a calibration signal supplying portion for supplying calibration signals having predetermined symbol patterns to the radio receiving portions, a calibration signal extracting portion for extracting the calibration signals having passed through the radio receiving portions, a receiving quality detecting portion for determining the radio receiving portion having the best receiving quality from the calibration signals having passed through the radio receiving portion and for selecting the radio receiving portion as a reference branch, and a calibration signal processing portion for creating correction information for correcting the receiving-oriented patterns by using at least one of the phase differences and amplitude ratios between the calibration signals having passed through the radio receiving portions and a calibration signal having passed through the reference branch. The characteristic of the invention is that the receiving quality detecting portion is provided.

According to one embodiment of the apparatus of the invention, the calibration signal supplying portion multiplexes the calibration signals to the inputs of the radio receiving portions.

According to another embodiment of the apparatus of the invention, the receiving quality detecting portion determines the radio receiving portion having the best receiving quality based on the SIR values estimated from the calibration signals having passed through the radio receiving portions or based on the error rates of the calibration signals having passed through the radio receiving portions.

### BRIEF DESCRIPTION OF THE DRAWINGS

FIG. 1 is a diagram showing an example of a block construction in a conventional array antenna receiving apparatus;

FIG. 2 is a diagram showing symbol points obtained by demodulating calibration signals;

FIG. 3 is a diagram showing symbol points obtained by normalizing the symbol points in FIG. 2;

FIG. 4 is a diagram showing a state of a symbol point Sn (In, Qn) obtained by demodulating an arbitrary calibration signal;

FIG. 5 is an enlarged diagram showing the vicinity of the symbol point Sn in FIG. 4;

FIG. 6 is a diagram showing relative positions of the other symbol points when the phase error of a reference symbol point S1 is the maximum and the amplitude error is zero;

FIG. 7 is a diagram showing the relative magnitudes of amplitudes of the other symbol points when the amplitude error of the reference symbol point S1 is the maximum in FIG. 6;

FIG. 8 is a diagram showing an embodiment of the block construction of the array antenna receiving apparatus of the invention;

FIG. 9 is a diagram showing the states of changes in SIR estimated value of three branches and in SIR estimated value in the reference branch; and

FIG. 10 is a diagram showing an embodiment of the block construction of another array antenna receiving apparatus different from the one shown in FIG. 8.

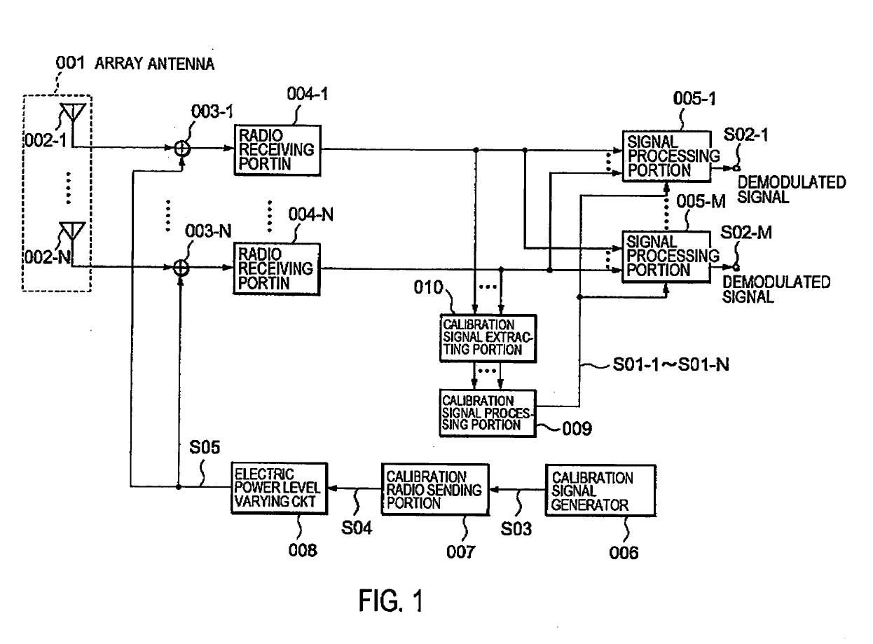

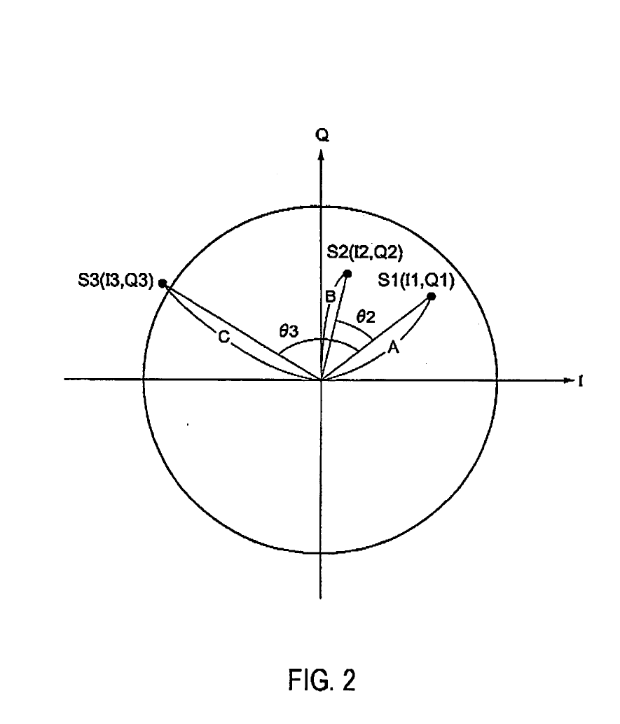

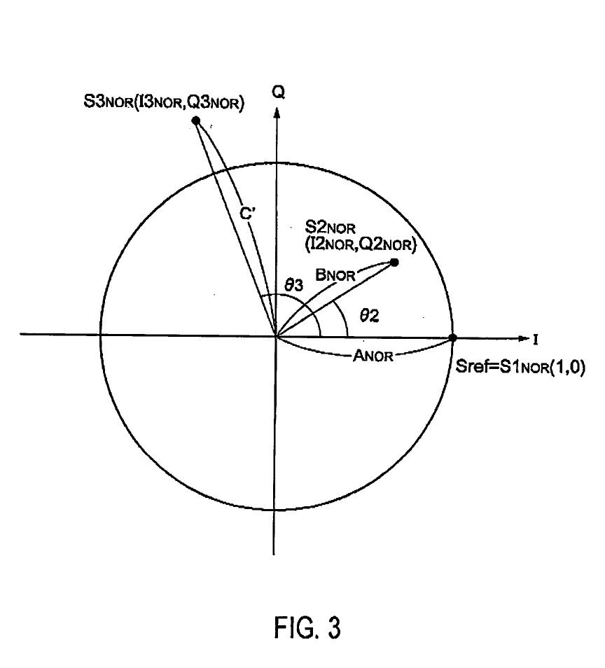

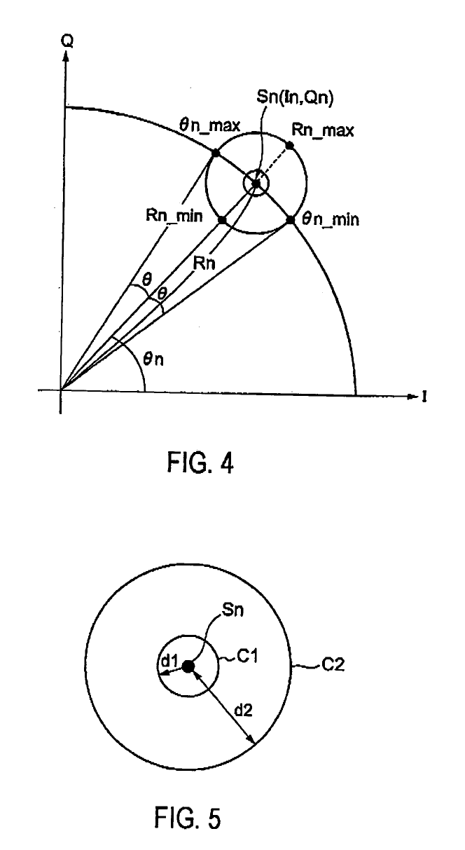

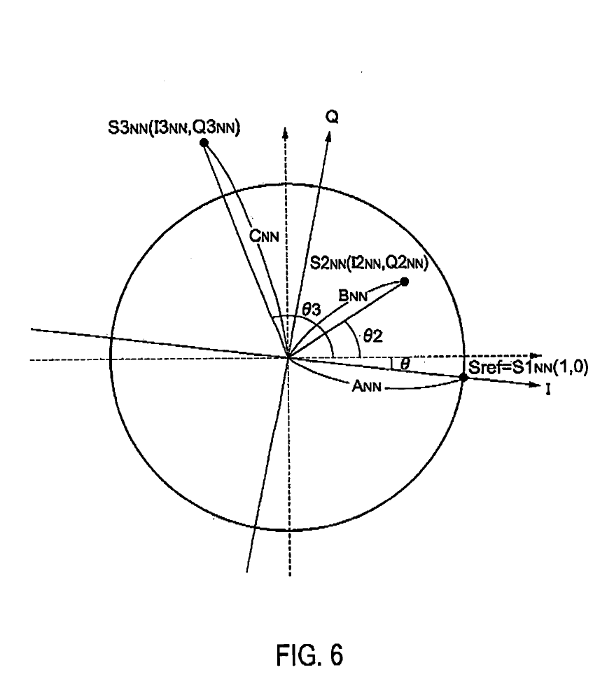

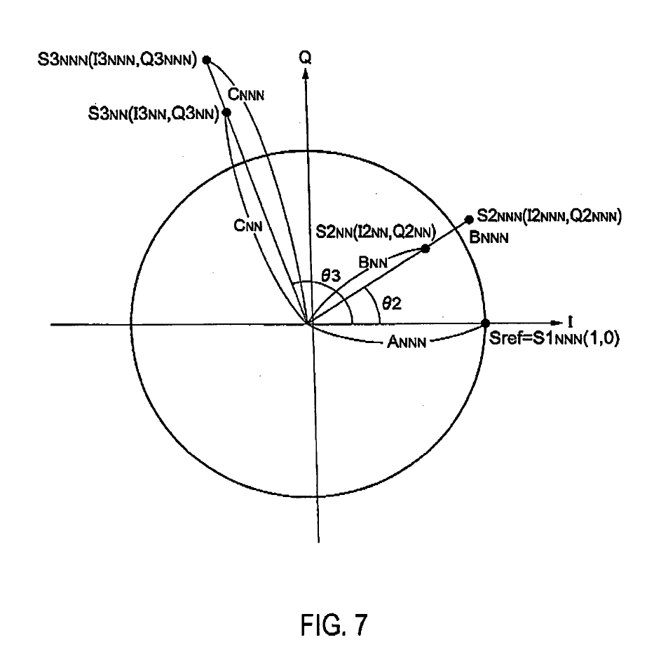

### BEST MODE FOR CARRYING OUT THE INVENTION

The invention will be described in detail with reference to the appended drawings.

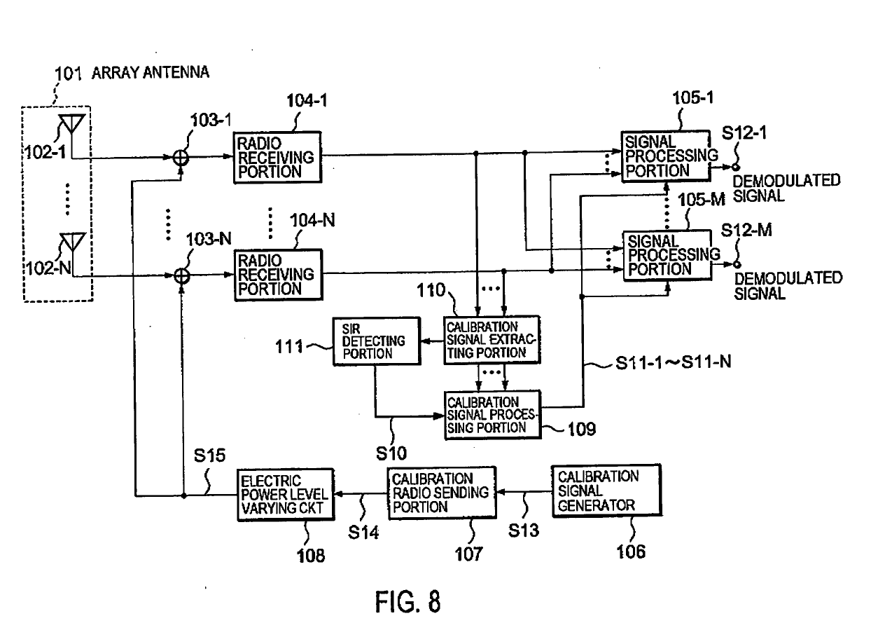

FIG. 8 is a diagram showing an embodiment of a block construction in an array antenna receiving apparatus of he invention.

The shown array antenna receiving apparatus includes array antenna 101, multiplexing circuits 103-1 to 103-N, radio receiving portions 104-1 to 104-N, signal processing portions 105-1 to 105-M, a calibration signal generator 106, a calibration radio sending portion 107, an electric power level varying circuit 108, a calibration signal processing portion 109, a calibration signal extracting portion 110, and an SIR detecting portion 111. In the array antenna receiving apparatus, the array antenna 101 includes N antenna elements 102-1 to 102-N. The array antenna receiving apparatus can modulate signals equal to a number M of users.

The differences from the conventional apparatus are that one radio receiving portion having the best receiving quality is determined based on calibration signals having passed through multiple radio receiving portions and that the SIR detecting portion 111 is additionally provided as a receiving quality detecting portion for selecting the radio receiving portion as a reference branch.

The antenna elements 102-1 to 102-N are located closely to each other such that the receiving signals can highly correlate with each other.

The multiplexing circuits 103-1 to 103-N are connected to respectively corresponding antenna elements 102-1 to 102-N. The multiplexing circuits 103-1 to 103-N multiplex, in the radio band, calibration signals supplied from the electric power level varying circuit 108 and output signals of the respectively corresponding antenna elements 102-1 to 102-N and outputs the results to the radio receiving portions 104-1 to 104-N. The multiplexing method is not limited in particular. Though a code-division multiplexing example is typically shown, time-division multiplexing or frequency-division multiplexing may be used.

Each of the radio receiving portions 104-1 to 104-N includes a low-noise amplifier, a band-limited filter, a mixer, a local oscillator, a total receiving electric power detecting portion, an Auto Gain Controller (AGC), an orthogonal detector, a low-pass filter, an analog-to-digital converter (ADC) and so on. The radio receiving portions 104-1 to 104-N are connected to the respectively corresponding multiplexing circuits 103-1 to 1 03-N. The radio receiving portions 104-1 to 104-N receive radio waves, convert to digital signals, and output through the respective antenna elements 102-1 to 102-N. For example, the radio receiving portion 104-i corresponding to the antenna element 102-i performs such functions as the amplification, frequency conversion from the radio band to the base band, orthogonal detection, and analog-to-digital conversion on input signals received from the multiplexing circuit 103-i. Then, the radio receiving portion 104-i outputs the result to the calibration signal extracting portion 110 and the signal processing portions 105-1 to 105-M. Each of the radio receiving portions 104-1 to 104-N has the same construction as that of the radio receiving portion 104-i. Signals received from the multiplexing circuit 103-1 to 103-N are input to the radio receiving portions 104-1 to 104-N, respectively.

Signals output from all of the radio receiving portions 104-1 to 104-N are sent to the calibration signal extracting portion 110. The calibration signal extracting portion 110 extracts calibration signals multiplexed to signals output from the radio receiving portions 104-1 to 104-N and sends the extracted calibration signals to the SIR detecting portion 111 and the calibration signal processing portion 109 together with branch information for identifying which antenna radio receiving portion the calibration signal is output from. In the example where code-division multiplexing is performed on calibration signals, the calibration signal extracting portion 110 performs the inverse-diffusion for extracting calibration signals.

The SIR detecting portion 111 estimates SIR (signal-to-interference ratio) value of branches based on the respective symbol points:obtained by demodulating the branch information and calibration signals received from the calibration signal extracting portion 110. Here, the SIR detecting portion 111 selects the branch having the largest SIR value among the SIR estimated values of all of the branches as a reference branch. Then, the SIR detecting portion 111 informs the reference branch to the calibration signal processing portion 109 through a reference branch select signal S10. In other words, the SIR detecting portion 111 selects one radio receiving portion based on the SIR estimated value as the reference branch having the best receiving quality.

The calibration signal processing portion 109 inputs the output signal of the calibration signal extracting portion 110 and the reference branch select signal S10 from the SIR detecting portion 111. Then, the calibration signal processing portion 109 determines, as a reference symbol point, a symbol point by demodulating a calibration signal extracted from the output signal of the reference branch determined by the SIR detecting portion 111. Next, the calibration signal processing portion 109 obtains phase/amplitude correction information S11-1 to S11-N of symbol points obtained by demodulating calibration signals extracted from the output signals of all of the branches and output the phase/amplitude correction information S11-1 to S11-N to the signal processing portions 105-1 to 105-M.

The signal processing portions 105-1 to 105-M use the phase/amplitude correction information S11-1 to S11-N output from the calibration signal processing portion 109 to correct output signals of all of the radio receiving portion 104-1 to 104-N. At the same time, the signal processing portions 105-1 to 1 05-M form a receiving-oriented pattern (called optimum receiving-oriented pattern hereinafter) in which the receiving gain to the user signal incoming direction is increased for each user and the receiving gain is decreased against the interference from the other user and/or the interference due to delay waves. Each of the signal processing portions 105-1 to 105-M combines output signals of the radio receiving portions 104-1 to 104-N in accordance with the receiving-oriented pattern and obtains a desired demodulated signal.

The calibration signal generator 106 creates a calibration signal S13 in the base band and outputs the calibration signal S13 to the calibration radio sending portion 107. The calibration signal generator 106 can generate an arbitrary symbol pattern, as the calibration signal S13, based on the changeably set value.

The calibration radio sending portion 107 performs the digital-to-analog conversion, the frequency conversion from the base band to the radio band on the calibration signal S13 in the base band received from the calibration signal generator 106. Then, the calibration radio sending portion 107 sends out the result to the electric power level varying circuit 108 as a calibration signal S14 in the radio band.

The electric power level varying circuit 108 receives the calibration signal S14, which is output from the calibration radio sending portion 107 and which has the same frequency band as that of the signals received in the antenna elements 102-1 to 102-N. Then, the electric power level varying circuit 108 level-converts the calibration signal S14 to an arbitrary electric level and sends out the result to the multiplexing circuits 103-1 to 103-N as a calibration signal S15.

Therefore, calibration signals are supplied to radio receiving circuits 104-1 to 104-N by the calibration signal generating portion 106, the calibration signal radio sending portion 107, the electric power level varying circuit 108, and the multiplexing circuits 103-1 to 103-N.

Next, an operation of this embodiment will be described with reference to FIG. 8.

The antenna elements 102-1 to 102-N receive signals in which desired signals and multiple interference signals are multiplexed. However, when the number of antenna elements are increased, the correlation between antenna elements, which are located apart, that is, which are not adjacent to each other, is decreased. As a result, the electric power of the multiplexing signals received by the antenna elements 102-1 to 102-N varies largely. In other words, different kinds of electric power are input to the antenna elements 102-1 to 102-N of the array antenna receiving apparatus.

The calibration signal S13 in the base band, which is generated by the calibration signal generator 106, undergoes frequency conversion and amplification by the calibration radio sending portion 107 and becomes the calibration signal S14. Then, as the known calibration signal S15 having an arbitrary electric power level is output to the all of the multiplexing circuits 103-1 to 103-N by the electric power level varying circuit 108. The multiplexing circuits 103-1 to 103-N multiplex the calibration signal S15, which is output from the electric power level varying circuit 108, to the signals received by the antenna elements 102-1 to 102-N and output the result to the radio receiving portions 104-1 to 104-N. The signal output from the multiplexing circuits 103-1 to 103-N is a signal in which the calibration signal S15, a desired (user) signal, interference (other users) signals and thermal noise and multiplexed.

The electric power level of the calibration signal and the thermal noise can be regarded as the same in each of the multiplexing circuits 103-1 to 103-N. Therefore, the differences in received electric power among the radio receiving portions 104-1 to 1 04-N are directly the electric differences caused based on the sum of the desired signal and interference signal input from the antenna elements 102-1 to 102-N. Focusing on the calibration signal, the other signals become interference waves against the calibration signal. Therefore, the electric power difference can be regarded as the electric power difference in interference wave against the calibration signal.

The radio receiving portions 104-1 to 104-N perform the amplification, frequency conversion from the radio band to the base band, orthogonal detection, and analog-to-digital conversion on signals received from the respective multiplexing circuits 103-1 to 103-N. Then, the radio receiving portions 104-1 to 104-N send out the result to the calibration signal extracting portion 110 and all of the signal processing portion 105-1 to 105-M. The calibration signal extracting portion 110 extracts calibration signals from signals received from all of the radio receiving portions 104-1 to 104-N and sends out the extracted calibration signals to the SIR detecting portion 111 and the calibration signal processing portion 109 together with branch information.

The SIR detecting portion 111 estimates SIR values based on symbol points S1 to SN obtained by demodulating the calibration signals extracted from the signals received from all of the radio receiving portions 104-1 to 104-N and determines SIR estimated values of the branches. Then, the SIR detecting portion 111 compares the SIR estimated values of the branches and informs the branch having the largest SIR value as the reference branch to the calibration signal processing portion 109 through a reference branch select signal S10.

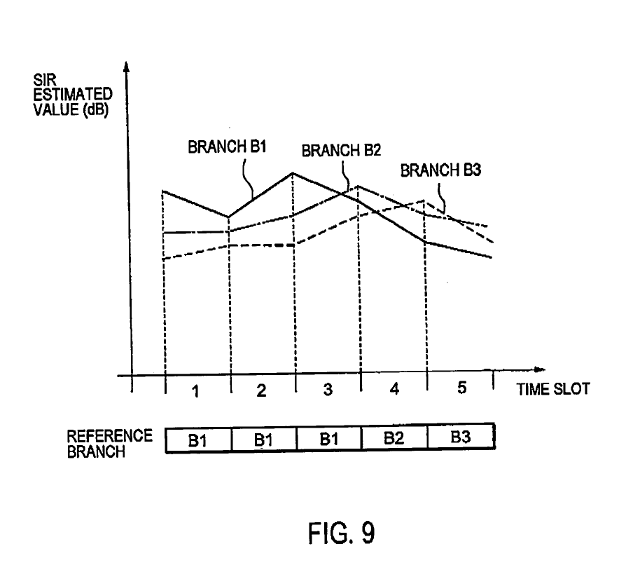

FIG. 9 is a diagram showing a state of changes in SIR estimated values of three branches B1, B2 and B3 and changes in reference branch. The SIR estimated values of symbol points output from the branches are calculated every time when the time slot is switched. Then, the branch having the largest SIR value is selected as the reference branch at each time slot. In the example shown in FIG. 9, when the branches B1 to B3 are the radio receiving portions 104-1 to 104-3, for example, the radio receiving portion 104-1 of the branch B1 is selected as the reference branch at the time slots TS1 to TS3. At the time slot TS4, the radio receiving portion 104-2 of the branch B2 is selected as the reference branch. At the time slot TS5, the radio receiving portion 104-3 of the branch B3 is selected as the reference branch.

The reference branch select signal S10 is output to the calibration signal processing portion 109. The calibration signal processing portion 109 creates phase/amplitude correction information S11-1 to S11-N by using, as the reference symbol point, the symbol point obtained by demodulating the calibration signal extracted from the output of the radio receiving portion selected as the reference branch. Thus, the phase offset in the symbol points output from all of the branches becomes the minimum, and the error in the amplitude ratio between the reference symbol point and the other symbol points becomes minimum. Then, the calibration signal processing portion 109 outputs the phase/amplitude correction information S11-1 to S11-N to all of the signal processing portions 105-1 to 105-M.

The signal processing portions 105-1 to 105-M correct and form respective optimum receiving-oriented patterns by using the phase/amplitude correction information S11-1 to S11-N. Then, the signal processing portions 105-1 to 105-M combine the output signals of the radio receiving portions 104-1 to 104-N in accordance with the receiving-oriented pattern and obtain desired demodulated signals S12-1 to S12-M.

Therefore, according to this embodiment, the radio receiving portion having the largest SIR estimated value is selected as the reference branch at every time slot and computes the phase differences and amplitude ratios between the reference symbol point obtained as a result and the other symbol points. Therefore, the error can be always minimized, and the calibration can be performed highly precisely. Furthermore, the radio receiving portion having a small SIR estimated value is not selected as the reference branch. Thus, the broken radio receiving portion is not selected as the reference branch. Therefore, the redundancy construction can be provided against the failures of the reference branch, and the reliability of the apparatus can be improved.

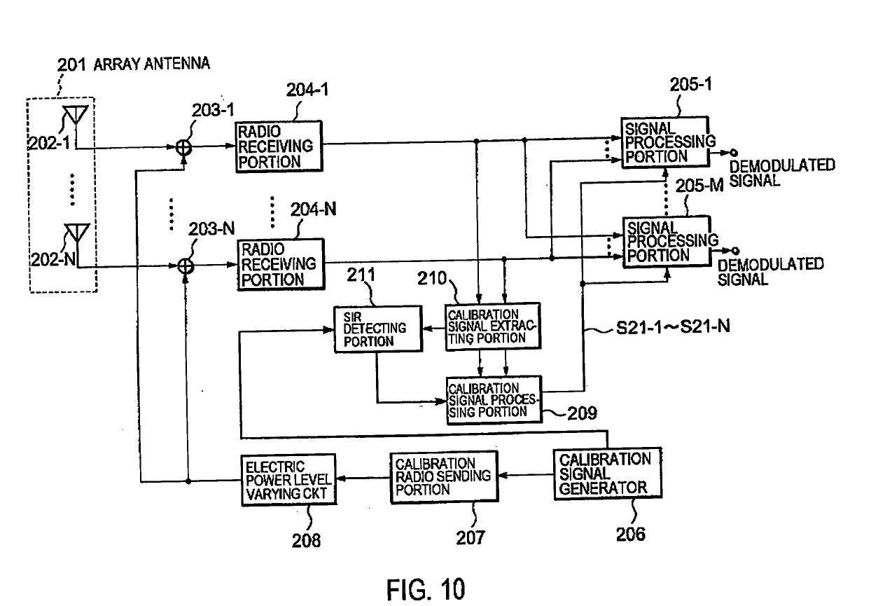

Next, another embodiment of the invention will be described with reference to FIG. 10.

FIG. 10 is a diagram showing an embodiment of the block construction of the array antenna receiving apparatus, which is different from the one in FIG. 8, according to the invention. The array antenna receiving apparatus in FIG. 8 selects a radio receiving portion having the best receiving quality based on the SIR value. On the other hand, the array antenna receiving apparatus in FIG. 10 selects a radio receiving portion having the best receiving quality based on the bit error rate.

The array antenna receiving apparatus in FIG. 10 includes an array antenna 201, multiplexing circuits 203-1 to 203-N, radio receiving portions 204-1 to 204-N, signal processing portions 205-1 to 205-M, a calibration signal generator 206, a calibration radio sending portion 207, an electric power level varying circuit 208, a calibration signal processing portion 209, a calibration signal extracting portion 210, and an error rate detecting portion 211.

The array antenna 201, multiplexing circuits 203-1 to 203-N, radio receiving portions 204-1 to 204-N, signal processing portions 205-1 to 205-M, calibration radio sending portion 207, electric power level varying circuit 208, calibration signal processing portion 209 and calibration signal extracting portion 210 in FIG. 10 are the same as the array antenna 101, multiplexing circuits 103-1 to 103-N, radio receiving portions 104-1 to 104-N, signal processing portions 105-1 to 105-M, calibration radio sending portion 107, electric power level varying circuit 108, calibration signal processing portion 109 and calibration signal extracting portion 110, respectively, in FIG. 8.

The calibration signal generator 206 generates an arbitrary symbol pattern like the calibration signal generator 106 in FIG. 8 and additionally informs the generated symbol pattern and the sending timing to the error rate detecting portion 211.

The error rate detecting portion 211 compares the calibration signals of the branches extracted from the calibration signal extracting portion and the symbol pattern informed by the calibration signal generator 206 based on the sending timing informed from the calibration signal generator 206 similarly, and computes the bit error rate (BER) for each branch. Then, the error rate detecting portion 211 selects the branch having the smallest bit error rate as the reference branch and outputs the result to the calibration signal processing portion 209 as the reference branch select signal.

Therefore, the same effects as those of the array antenna receiving apparatus in FIG. 8 can be obtained by the array antenna receiving apparatus in FIG. 10.

In other words, according to the invention, the phase differences and amplitude ratios of other radio receiving portions are obtained by using the radio receiving portion having the best receiving quality as the reference. Thus, the error of the reference branch can be minimized, and the other radio receiving portions can be corrected thereby. Therefore, the calibration can be always performed highly precisely.

Furthermore, since the radio receiving portion having the best receiving quality is selected as the reference, the radio receiving portion having a problem is not selected as the reference branch. Therefore, the redundancy construction can be provided against the failure in the reference branch, and the reliability of the apparatus can be improved.

Additionally, the calibration and the radio communication can be performed at the same time.

### INDUSTRIAL APPLICABILITY

As described above, the array antenna receiving apparatus according to the present invention is suitable for an array antenna receiving apparatus, which can select a radio receiving portion having the best receiving quality when a reference branch is determined. In this case, the reference branch is referenced for correcting changes in phase and amplitude among radio receiving portions of array antennas. By using the above-described method and apparatus, the calibration precision can be improved, and the normal calibration can be performed even when a specific radio receiving portion has a problem.

1. A calibration method for an array antenna receiving apparatus having an array antenna (101) including a plurality of antenna elements (102) for forming a receiving-oriented pattern and radio receiving portions (104) corresponding to the antenna elements,
the method comprising the steps of:
supplying calibration signals having predetermined symbol patterns to the radio receiving portions; extracting the calibration signals having passed through and output from the radio receiving portions; selecting a predetermined one of the radio receiving portions as a reference branch; and correcting the receiving-oriented pattern by using at least one of the phase differences and amplitude ratios between the calibration signals having passed through the other radio receiving portions and the calibration signal having passed through the reference branch,
wherein the step of selecting as the reference branch determines the radio receiving portion having the best receiving quality from the calibration signals having passed through the radio receiving portions.

2. A calibration method for an array antenna receiving apparatus according to claim 1, wherein the step of supplying calibration signals having predetermined symbol patterns to the radio receiving portions multiplexes the calibration signals to input signals and supplies to the radio receiving portions.

3. A calibration method for an array antenna receiving apparatus according to any one of claims 1 and 2, wherein the step of selecting the radio receiving portion as the reference branch determines the radio receiving portion having the best receiving quality based on the SIR values estimated from the calibration signals having passed through the plurality of radio receiving portions.

4. A calibration method for an array antenna receiving apparatus according to any one of claims 1 and 2, wherein the step of selecting the radio receiving portion as the reference branch determines the radio receiving portion having the best receiving quality based on the error rates of the calibration signals having passed through the radio receiving portion.

5. An array antenna receiving apparatus having an array antenna (101) including a plurality of antenna elements (102) for forming a receiving-oriented pattern, radio receiving portions (104) corresponding to the antenna elements, calibration signal supplying portions (103, 106-108) for supplying calibration signals having predetermined symbol patterns to the radio receiving portions, a calibration signal extracting portion (110) for extracting the calibration signals having passed through the radio receiving portions, and a calibration signal processing portion (109) for selecting predetermined one of the radio receiving portions as a reference branch and for creating correction information for correcting the receiving-oriented patterns by using at least one of the phase differences and amplitude ratios between the calibration signals having passed through the radio receiving portion and a calibration signal having passed through the reference branch,
wherein a receiving quality detecting portion (111) is further provided for determining the radio receiving portion having the best receiving quality from the calibration signals having passed through the radio receiving portion and for selecting the radio receiving portion as a reference branch, and the calibration signal processing portion receives information on the radio receiving portion to be the reference branch from the receiving quality detecting portion and creates correction information for correcting the receiving-oriented pattern by using at least one of the phase differences and amplitude ratios between the calibration signal having passed through the radio receiving portion that is the reference branch and the calibration signals having passed through the other radio receiving portions.

6. An array antenna receiving apparatus according to claim 5, wherein the calibration signal supplying portion multiplexes the calibration signals to the inputs of the radio receiving portions.

7. An array antenna receiving apparatus according to any one of claims 5 and 6, wherein the receiving quality detecting portion determines the radio receiving portion having the best receiving quality based on the SIR values estimated from the calibration signals having passed through the radio receiving portions.

8. An array antenna receiving apparatus according to any one of claims 5 and 6, wherein the receiving quality detecting portion determines the radio receiving portion having the best receiving quality based on the error rates of the calibration signals having passed through the radio receiving portions.
